(19) United States
(12) Patent Application Publication
(10) Pub. No.: US 2023/0396125 A1
(43) Pub. Date: Dec. 7, 2023

(54) FLYWHEEL POWER STORAGE DEVICE

(71) Applicant: NexFi Technology Inc., Suita-shi, Osaka (JP)

(72) Inventors: Satoshi TANIMOTO, Suita-shi, Osaka (JP); Takashi NAKAMURA, Suita-shi, Osaka (JP)

(21) Appl. No.: 18/032,429

(22) PCT Filed: Oct. 1, 2021
(86) PCT No.: PCT/JP2021/036532

§ 371 Date: Apr. 18, 2023

(30) Foreign Application Priority Data
Oct. 28, 2020 (JP) 2020-180454

(51) Int. Cl. H02K 7/02; F03G 3/08

(52) U.S. Cl. CPC H02K 7/025; F03G 3/08

(57) ABSTRACT

A flywheel energy storage system that can not only be miniaturized but also can be dramatically improved in a maximum device mass energy density is provided. The flywheel energy storage system includes a flywheel unit (2) in which flywheel hubs (8A), (8B) that are provided with rotary mass circular wheels (9A), (9B) on outer peripheries thereof are supported on support shafts (5A), (5B), and an electrical motor/generator unit (3) that is provided with a stator unit (10) formed by a coreless induction coil (11i) between the flywheel hubs (8A), (8B) that hold rotor units (12A), (12B) formed by a yokeless annular permanent magnet Halbach array.

### TECHNICAL FIELD

The present disclosure relates to a technique for improving a mass energy density of a flywheel energy storage system (hereafter, often abbreviated as “FESS”).

### BACKGROUND ART

The FESS is a system having a function of storing electric energy in a flywheel and, conversely, supplying electric energy from the flywheel via means for converting an electric energy amount and rotational motion energy into each other.

Compared with an electrochemical energy storage system (so-called secondary battery) in widespread use, the FESS has excellent features such as functioning stably in both a low-temperature environment and a high-temperature environment, showing almost no deterioration of characteristics and life even after repeated charging and discharging, and low internal resistance.

By using the new energy storage system, it is possible to improve the environmental resistance, energy saving and system maintainability in related art using a secondary battery. Against the background, there is a strong demand for the further widespread use and the expansion of application areas of the FESS.

An important issue for the widespread use of the FESS is to achieve the miniaturization and weight reduction of the entire system. The weight reduction can be paraphrased as “improvement of a maximum device mass energy density” from a viewpoint of a device maximum mass energy density (value obtained by dividing the maximum stored energy of the flywheel by the mass of the device).

The FESS has two basic components. One is a flywheel unit that stores energy as rotational motion. The other one is an electrical motor/generator (hereafter, M/G) unit that mutually converts an electrical energy and rotational motion energy by a command.

Today, many efforts are devoted to miniaturizing the system volume. There is a significant tendency to integrate the flywheel unit and the M/G unit.

More specifically, the configuration in which the flywheel unit and the M/G unit are integrated (or unified) includes a configuration in which the flywheel unit and the M/G unit shares a rotary shaft and they are concentrically arranged in a concentric circle on one vertical plane of a rotation shaft.

As the integrated FESS, for example, the device described in Patent Literature 1 below is known. This FESS described in Patent Literature 1 includes an outer rotor type flywheel unit and a M/G unit.

The M/G unit and the flywheel unit share a rotary shaft, and the flywheel unit is disposed on the outside to surround an outer peripheral surface of the M/G unit. Further, the degree of integration is increased by providing a rotor unit of the M/G unit in a main body of the flywheel unit.

### CITATION LIST

### Patent Literature

Patent Literature 1: Japanese Patent No. 4160022

### SUMMARY OF INVENTION

### Technical Problem

However, in the integrated FESS in related art, as described above, although miniaturization of the system size can be achieved in some degree, the maximum device mass energy density, which is the maximum mass energy density in the flywheel power storage device, is hardly improved.

In view of the above points, an object of the present disclosure is to provide a FESS that can not only be miniaturized but also can dramatically improve a maximum device mass energy density.

### Solution to Problem

In order to achieve such an object, in the present disclosure, a flywheel energy storage system (FESS), including an electrical motor/generator (M/G) unit configured to mutually convert electrical energy and rotational motion energy, and a flywheel unit configured to store energy as rotational motion, includes a housing that accommodates both the M/G unit and the flywheel unit, in which the flywheel unit includes a support shaft of which a central axis coincides with a rotation axis of the flywheel unit, a pair of flywheel hubs coaxially supported by the support shafts, and a pair of rotary mass circular wheels provided on an outer periphery of each of the flywheel hubs, the M/G unit includes a stator unit formed by a coreless induction coil provided between the pair of flywheel hubs, and a rotor unit that faces the coreless induction coil of the stator unit and is formed by a yokeless annular permanent magnet Halbach array held by each of the flywheel hubs, and a housing that supports the support shaft to accommodate both the M/G unit and the flywheel unit is included.

In the present disclosure, it is preferable that one or more, or all of the flywheel hub, the support shaft, and the housing are made of a light metal or a carbon fiber reinforced plastic.

Further, in the present disclosure, an annular space is formed between the rotary mass circular wheel and the support shaft of the flywheel unit, and a bidirectional inverter unit configured to supply power to and receive power from the M/G unit is accommodated in the annular space.

Further, in the present disclosure, a vacuum pumping device configured to evacuate air to produce a vacuum in at least a rotation area of the M/G unit and the flywheel unit inside the housing is included inside the housing.

Further, in the present disclosure, a first energy storage unit constituted with the M/G unit and the flywheel unit and a second energy storage unit constituted with the M/G unit and the flywheel unit that rotate in a reverse direction at an identical speed with respect to the first power storage unit, and the flywheel unit are included, in which the first energy storage unit and the second energy storage unit are disposed with the same number on the same rotation axis.

The flywheel unit of the flywheel energy storage device is generally constituted with three main elements. A first element is a rotary mass circular wheel (referred to herein as a circular wheel including the case of a cylinder) that rotates in the circumferential direction and stores rotational motion energy. A second element is a support shaft as a flywheel central shaft that defines a rotation center point of the rotary mass circular wheel that rotates. A third element is a flywheel hub that supports the rotary mass circular wheel and keeps the distance from the flywheel central shaft at an equal distance. The flywheel hub and the rotary mass circular wheel rotate integrally. The support shaft is supported by the housing, but examples include a configuration in which the support shaft is fixedly held by the housing to rotatably support the flywheel hub and a configuration in which the support shaft is rotatably supported by the housing to rotate integrally with the flywheel hub, and any configuration can be selectively adopted.

On the other hand, the basic components of the M/G unit (referred to here by an example of a permanent magnet three-phase synchronous M/G that is widely used) are constituted with generally two components, that is, a stator unit including fixed excitation induction coils and a rotatable rotor unit in which permanent magnets that generate a strong static magnetic field are installed or embedded in a surface layer. The stator unit and the rotor unit are disposed to share a central axis, and the excitation induction coil of the stator unit and the permanent magnets of the rotor unit face each other with a narrow gap interposed therebetween.

The FESS of the present disclosure is realized by rationally reducing the number of steel parts that are high load generating elements, based on the guideline that the mass energy density of the rotary mass circular wheel of the flywheel unit is maximized and not lowered.

Accordingly, according to the present disclosure, it is possible to provide a FESS that can not only be miniaturized but also can be dramatically improved in the maximum device mass energy density.

### BRIEF DESCRIPTION OF DRAWINGS

FIG. 1 is an explanatory cross-sectional view illustrating a configuration of a FESS according to a first embodiment of the present disclosure.

FIG. 2 is an explanatory cross-sectional view illustrating a configuration of a FESS according to a second embodiment of the present disclosure.

FIG. 3 is an explanatory cross-sectional view illustrating a configuration of a FESS according to a third embodiment of the present disclosure.

FIG. 4 is an explanatory cross-sectional view illustrating a configuration of a FESS according to a fourth embodiment of the present disclosure.

FIG. 5 is an explanatory cross-sectional view illustrating a configuration of a FESS according to a fifth embodiment of the present disclosure.

FIG. 6 is an explanatory cross-sectional view illustrating a configuration of a FESS according to a sixth embodiment of the present disclosure.

FIG. 7 is an explanatory cross-sectional view illustrating a configuration of a FESS according to a seventh embodiment of the present disclosure.

### DESCRIPTION OF EMBODIMENTS

The FESS of each embodiment of the present disclosure is realized by rationally reducing the number of iron parts that are high load generating elements, based on the guideline that the energy density of the rotary mass circular wheel in the flywheel unit is maximized

When it is assumed that M_{sys} is the total system mass (the sum of the mass of the flywheel unit and the mass of the M/G unit) of the FESS and E_{fw} is the maximum rotational motion energy stored in the rotary mass circular wheel of the flywheel unit, the total maximum system mass energy density D_{sys} of the FESS is defined by Equation (1) below.

D_{sys}=E_{fw}/M_{sys} (1)

On the other hand, the maximum wheel mass energy density D_{fw} is widely used as an index indicating the performance of the rotary mass circular wheel. When it is assumed that the mass of the rotary mass circular wheel is m_{fw}, the following Equation (2) is obtained.

D_{fw}=E_{fw}/m_{fw} (2)

In order to know the relationship between the D_{fw} and the material of the rotary mass circular wheel, when E_{fw} and m_{fw} in the above equation are expressed as a mathematical equation, where ρ is the mass density (or specific gravity) of the rotary mass circular wheel and σ_{y} is the yield strength and an operation is performed, the following Equation (3) is finally derived.

D_{fw}=K(σ_{y}/ρ) (3)

Here, K is a coefficient that gradually increases monotonically from 0.3 to 0.5 according to the ratio of the inner radius and the outer radius of the rotary mass circular wheel, and is sometimes called a shape factor.

By combining the above Equations (1) and (2), the following relational Equation (4) between the D_{sys} and the D_{fw} is obtained.

D_{sys}=(m_{fw}/M_{sys})D_{fw}=(m_{fw}+Mₒₜₕ))D_{fw} (4)

Mₒₜₕ in the above Equation (4) is a quantity obtained by subtracting the mass m_{fw} of the rotary mass circular wheel from the mass M_{sys} of the FESS, that is, the total mass excluding the rotary mass circular wheel.

The present inventor pays attention to the middle side of Equation (4) in the above analysis, and in order to improve the maximum system mass energy density D_{sys}, it is found that the above can be achieved by increasing the product of the mass ratio m_{fw}/M_{sys} of the rotary mass circular wheel and the FESS and the energy density D_{fw} of the rotary mass circular wheel.

Furthermore, the right side of Equation (4) reveals that the following two design processes are effective to improve the total maximum system mass energy density D_{sys}: that is, as a first step, a rotary mass circular wheel material (having a large σ_{y}/ρ ratio) is selected to maximize the D_{fw}, and in a subsequent second step, the Mₒₜₕ is reduced to the maximum extent possible on the premise that a desired performance (output and torque) of the M/G unit can be sufficiently ensured.

Based on the above, in the present disclosure, in order to obtain the maximum of D_{fw}, the rotary mass circular wheel made of carbon fiber reinforced plastic (hereinafter, CFRP) used, in order to reduce the mass Mₒₜₕ, an axial flux permanent magnetic (hereinafter abbreviated as AFPM) M/G is disposed in the space on the inner diameter side of the same circular wheel, and an iron bulk material (for example, a flywheel hub, a yoke of a motor, a coil core, and the like) that occupies most of Mₒₜₕ is removed or switched to a lightweight material, so that improvements are performed.

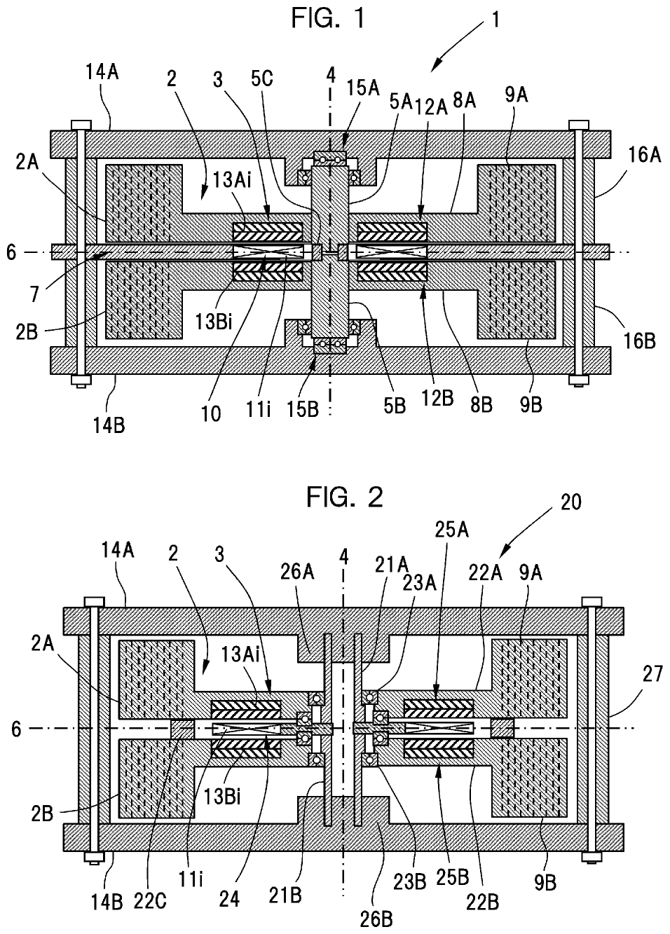

Hereinafter, embodiments of the present disclosure and modification examples thereof will be described with reference to the drawings. Note that, in these drawings, in order to facilitate understanding, the relationship between the thickness and the plane dimension and the ratio of the thickness of each layer are exaggerated. Further, the same members will be assigned the same reference numerals and the description thereof will be omitted again.

[First Embodiment] In the flywheel power storage device 1 according to the first embodiment, as illustrated in FIG. 1, a flywheel unit 2 and a M/G unit 3 are integrated and rotate together with vertical rotary shafts 5A and 5B, which are installed on a rotation central axis 4 (Z-axis of a polar coordinate system) and are common support shafts, to charge and discharge electricity.

A reference numeral 5C is a coupling shaft that connects the vertical rotary shafts 5A and 5B. A reference numeral 6 is a central rotation plane (r-θ plane in the polar coordinate system) perpendicular to the rotation central axis 4.

For the materials of the vertical rotary shafts 5A and 5B and the coupling shaft 5C, a light metal having a high yield strength is selected. For example, it is preferable to use an ultra-super duralumin (A7075P) or 6Al-4V titanium alloy, and it is even more desirable to use a 6Al-6V-2Sn titanium alloy or an 11.5Al-1Mo-6Zr-4.5Sn titanium alloy.

The flywheel unit 2 is disposed such that an upper flywheel 2A and a lower flywheel 2B are parallel to each other and the structure thereof is vertically symmetrical with a central gap 7 provided on a central rotation plane 6 interposed therebetween.

A reference numeral 8A is a flywheel hub of the upper flywheel 2A and has a cylindrical shape provided with a bottom plate. The flywheel hub 8A is fixed to or mechanically firmly connected to the upper rotary shaft 5A.

Similarly, a reference numeral 8B is a flywheel hub of the lower flywheel 2B and has a cylindrical shape with a bottom plate (on top). The flywheel hub 8B is fixed to or mechanically firmly connected to the lower rotary shaft 5B.

As the material of the flywheel hubs 8A and 8B, a light metal having a high yield strength or carbon fiber reinforced plastic (CFRP) is selected.

In the case of a light metal, for example, it is preferable to use an ultra-super duralumin (A7075P) or 6Al-4V titanium alloy, and it is even more desirable to use a 6Al-6V-2Sn titanium alloy or an 11.5Al-1Mo-6Zr-4.5Sn titanium alloy.

In the case of CFRP, it is desirable to use a reinforced plastic obtained by bundling carbon fibers having a tensile strength of 5 GPa or more at a filling ratio of 0.6 or more.

An upper rotary mass circular wheel 9A and a lower rotary mass circular wheel 9B of a cylindrical shape adhere tightly to the outer edges of the flywheel hubs 8A and 8B, respectively.

For the rotary mass circular wheels 9A and 9B, CFRP having a filling ratio of 60% to 70%, which is obtained by winding and strengthening carbon fibers having a tensile strength of 6 GPa or more in the circumferential direction, is used. Such a CFRP can be formed by using a filament winding method or a sheet winding method in related art.

As described above, the AFPM type M/G is adopted in the M/G unit 3. In FIG. 1, a reference numeral 10 is a stator unit of the M/G unit 3, and the form thereof is a hollow disk having a circular hole having an inner diameter larger than the outer diameter of the coupling shaft 5C.

The stator unit 10 is disposed to be separated from the upper flywheel 2A and the lower flywheel 2B by a slight gap at the position of the central gap 7. Inside the stator unit 10 that is closer to the rotary shafts 5A and 5B and is separated from the rotation central axis 4 by a predetermined distance, a plurality of coreless induction coils 11(i=1, 2, . . . , n) with the magnetic flux interlacing surface directed in the Z-axis direction are disposed and fixed in the circumferential direction at equiangular periods.

As the material of the stator unit 10, a light metal having a high yield strength, carbon fiber reinforced plastic (CFRP), or a composite material of both materials is selected, except for the portion of the coreless induction coil 11i made of a copper wire.

In the case of a light metal, for example, it is preferable to use an ultra-super duralumin (A7075P) or 6Al-4V titanium alloy, and it is even more desirable to use a 6Al-6V-2Sn titanium alloy or an 11.5Al-1Mo-6Zr-4.5Sn titanium alloy.

In the case of CFRP, it is desirable to use a reinforced plastic obtained by bundling carbon fibers having a tensile strength of 5 GPa or more at a filling ratio of 0.6 or more.

In order to further reduce the weight of the stator unit 10, it is designed such that

a portion of the stator unit 10 is hollowed out, except for the portion corresponding to the coreless induction coil 11i and connection portions of the upper and lower support defense walls described later, as long as the structural strength limit allows, to have a beam structure. The AFPM type M/G unit 3 includes a pair of an upper rotor unit 12A and a lower rotor unit 12B in the drawing. The rotor units 12A and 12B are integrally formed with bottom plates of the upper flywheel hub 8A and the lower flywheel hub 8B.

Reference numerals 13Ai (i=1, 2, . . . , k) and 13Bi (i=1, 2, . . . , k) are elements of the rotor unit, and are yokeless annular permanent magnet Halbach arrays (where k≠n), which are attached such that a side on which the magnetic field is strengthened faces the coreless induction coil 11i (i=1, 2, . . . , n), where k≠n. The annular permanent magnet Halbach arrays 13Ai and 13Bi are fitted into and fixed to annular recesses (the depth is equal to the thickness of the permanent magnet or smaller than the thickness) hollowed out in the bottom plates of the upper flywheel hub 8A and the lower flywheel hub 8B, respectively. The magnetic pole N pole of the reference numeral 13Ai is disposed always to face the magnetic pole P pole of the reference numeral 13Bi, and the magnetic pole P pole of the reference numeral 13Ai is disposed always to face the magnetic pole N pole of the reference numeral 13Bi.

The M/G unit 3 is configured to use annular permanent magnet Halbach arrays capable of forming strong magnetic connection (circuiting) between adjacent permanent magnets. Therefore, there is no restriction on using a heavy magnetic material and yoke for the base materials of the rotor units 12A and 12B, and it is possible to apply a light metal or CFRP that is a light material. Moreover, the rotor units 12A and 12B and the flywheel hubs 8A and 8B can be made of the same base material.

Next, in the FESS 1 according to the first embodiment of the present disclosure, a portion related to the housing frame will be described.

Reference numerals 14A and 14B are a circular upper support plate and a lower support plate of the FESS 1, respectively. The upper support plate 14A supports the upper rotary shaft 5A via a bearing unit 15A formed of a pair of a radial bearing and a thrust bearing. Similarly, the lower support plate 14B supports the lower rotary shaft 5B via a lower bearing unit 15B. The bearing can be optionally selected from various bearings in related art, ball bearings, sliding bearings, air bearings, magnetic bearings, and the like.

An upper support defense wall 16A and a lower support defense wall 16B having a circular tubular shape support the support plates 14A and 14B and the stator unit and determine their mutual positional relationship. Both the support defense walls 16A and 16B also play a role of preventing the debris from jumping out in the event that the flywheel unit 2 rotating at high speed is damaged.

For the materials of the support plates 14A and 14B and the support defense walls 16A and 16B, a light metal having a high yield strength is selected. For example, it is preferable to use an ultra-super duralumin (A7075P) or 6Al-4V titanium alloy, and it is even more desirable to use a 6Al-6V-2Sn titanium alloy or an 11.5Al-1Mo-6Zr-4.5Sn titanium alloy. As a result, the weight reduction of the support plates 14A and 14B and the support defense walls 16A and 16B is achieved. The support plates 14A and 14B and the support defense walls 16A and 16B constitute the housing according to the present disclosure.

In general, for a hollow wheel in which the ratio of the inner radius to the outer radius is large (ratio>0.6), the rotational stress generated in the circumferential direction is much higher than the rotational stress generated in the radial direction. The rotary mass circular wheels 9A and 9B of the FESS 1 correspond to the above.

In the first embodiment, CFRP (filling ratio: 60% to 70%) reinforced by winding carbon fibers having a tensile strength of 6 GPa or more in the θ direction around the rotary mass circular wheels 9A and 9B is used. Therefore, the rotary mass circular wheels 9A and 9B exhibit a very high yield strength in the circumferential direction. Further, in recent years, carbon fibers having a tensile strength of 6.4 GPa or more are commercially available. When manufactured using the above and an epoxy resin at a fiber filling ratio of 0.6, a CFRP having a mass density of 1.6 g/cm³ and a yield strength of σ_{y}=3.8 GPa can be obtained.

Here, the same CI-RP and the nickel chrome molybdenum steel SNCM439 known as a high-strength industrial material are compared in the maximum wheel mass energy density D_{fw} (relative value) using the σ_{y}/ρ value, and it is found that the CFRP flywheel adopted in the first embodiment can obtain the D_{fw} that is an order of magnitude higher than the D_{fw} of SNCM439 flywheel (for the relationship between σ_{y}/ρ and D_{fw}, refer to the previous Equation (2)).

Further, even when the D_{fw} is compared with those of other industrial materials, the overwhelming superiority of the CFRP flywheel remains unchanged. As a result, it can be confirmed that the first step in the above-described design process is highly satisfied.

Next, with respect to the second step in the design process described above, the achievement level of the present embodiment is verified in comparison with related art.

In the FESS in related art, priority is given to downsizing the system size by following the material configuration of the traditional FESS. Therefore, a large amount of steel is used for a bulk component, and as a result, Mₒₜₕ becomes large, which is a factor pushing down the total maximum system mass energy density D_{sys}. Examples of the bulk component containing a large amount of steel include a rotary shaft, a flywheel hub, an excitation coil core and yoke of a M/G unit, a housing frame, and the like. It is presumed that the reason why the magnetic steel remains is that it is indispensable as an element for establishing the magnetic circuit of the M/G (because the integrated structure is not established when the magnetic steel is removed).

On the other hand, as described above, the FESS 1 in the first embodiment is configured such that the AFPM type M/G unit 3 including the rotor units 12A and 12B with a pair of yokeless annular permanent magnet Halbach arrays is adopted, and the rotor units 12A and 12B of the AFPM type M/G unit 3 are integrated with the flywheel hubs 8A and 8B, so that the steel of the bulk components can be wiped out (removed or changed to a lightweight material).

Therefore, the large reduction of Mₒₜₕ progresses remarkably, and the miniaturization of the system size and the improvement of the total maximum system mass energy density D_{sys} (corresponding to the weight reduction) are achieved at the same time.

[Second Embodiment] In the one shown in the first embodiment, a configuration is adopted in which the central shafts 5A, 5B, and 5C constituting the support shaft rotate integrally together with the rotary mass circular wheels 9A and 9B and the flywheel hubs 8A and 8B. A FESS 20 of the second embodiment to be described next adopts a configuration in which the central shaft, which is the support shaft, is stationary (fixed).

FIG. 2 illustrates a cross section when the FESS 20 in the second embodiment is cut along the rotation central axis 4 (Z-axis of the polar coordinate system). The same members as those in the first embodiment are designated by the same reference numerals, and description thereof will be omitted.

In FIG. 2, a reference numeral 21A is an upper stationary shaft, and a reference numeral 21B is a lower stationary shaft. Both the stationary shafts 21A and 21B are hollow (circular tubular) shafts. The central axis coincides with the rotation central axis 4. Also in the second embodiment, the fact that the flywheel unit 2 and the M/G unit 3 are integrated and rotated around the rotation central axis 4 (Z-axis of the polar coordinate system) to charge and discharge electricity is the same as the first embodiment, except that both the stationary shafts 21A and 21B do not rotate and are stationary from beginning to end.

As the material of the stationary shafts 21A and 21B, a light metal having a high yield strength is selected. For example, it is preferable to use an alloy such as ultra-super duralumin (A7075P) or 6Al-4V titanium, and it is more desirable to use a 6Al-6V-2Sn titanium alloy or an 11.5Al-1Mo-6Zr-4.5Sn titanium alloy.

A reference numeral 22A is a flywheel hub belonging to the upper flywheel 2A, and the shape is a cylinder provided with a bottom plate. The flywheel hub 22A is connected to the upper stationary shaft 21A via a radial bearing of an upper bearing unit 23A and to a stator unit 24 described later via a thrust bearing.

Similarly, a reference numeral 22B is a flywheel hub belonging to the lower flywheel 2B, and the shape is a cylinder provided with a bottom plate. The flywheel hub 22B is connected to the lower stationary shaft 21B via a radial bearing of a lower bearing unit 23B and to the stator unit 24 described later via the thrust bearing.

The bearings of the bearing units 23A and 23B can be optionally selected from various bearings in related art, ball bearings, sliding bearings, air bearings, magnetic bearings and the like.

A reference numeral 22C is a flywheel hub spacer that determines the width of the central gap 7, and is firmly connected to the upper flywheel hub 22A and the lower flywheel hub 22B after installation.

As the material of the flywheel hubs 22A and 22B, a light metal having a high yield strength is selected. For example, it is preferable to use an ultra-super duralumin (A7075P) or 6Al-4V titanium alloy, and it is even more desirable to use a 6Al-6V-2Sn titanium alloy or an 11.5Al-1Mo-6Zr-4.5Sn titanium alloy.

The upper rotary mass circular wheel 9A and the lower rotary mass circular wheel 9B of a cylindrical shape adhere tightly to the outer edges of the flywheel hubs 22A and 22B, respectively.

Reference numeral 24 denotes a stator unit of the M/G unit 3, and is firmly connected to the stationary shafts 21A and 21B. The stator unit 24 is disposed at the position of the central gap 7, and is separated from the upper flywheel 2A and the lower flywheel 2B by a slight gap. The stator unit 24 may have a hollow center or a solid center.

As the material of the stator unit 24, a light metal having a high yield strength is selected except for the coreless induction coil portion 11i made of a copper wire. For example, it is preferable to use an ultra-super duralumin (A7075P) or 6Al-4V titanium alloy, and it is even more desirable to use a 6Al-6V-2Sn titanium alloy or an 11.5Al-1Mo-6Zr-4.5Sn titanium alloy.

In order to further reduce the weight of the stator unit 24, a design is desirable such that a portion of the stator unit 24 is hollowed out, except for the portion corresponding to the coreless induction coil 11i and connection portions of the stationary shafts 21A and 21B, as long as the structural strength limit allows, to have a beam structure.

The AFPM type M/G unit 3 includes a pair of an upper rotor unit 25A and a lower rotor unit 25B on the upper and lower sides thereof. The rotor units 25A and 25B are integrally formed with the bottom plates of the flywheel hubs 22A and 22B, respectively. The reference numerals 13Ai (i=1, 2, . . . , k) and 13Bi (i=1, 2, . . . , k) are yokeless annular permanent magnet Halbach arrays attached to the rotor units 25A and as in the first embodiment.

The reference numerals 14A and 14B are an upper support plate and a lower support plate of a circular shape. Shaft fixing mechanisms 26A and 26B that firmly restrain the stationary shafts 21A and 21B are formed in the center of the support plates 14A and 14B.

It is a circular tubular support defense wall 27 that determines the positional relationship between the support plates 14A and 14B and supports both. The support defense wall 27 also plays a role of preventing the debris from jumping out in the unlikely event that the flywheel unit 2 or the M/G unit 3 that rotates at high speed is damaged.

For the materials of the support plates 14A and 14B and the support defense wall 27, a light metal having a high yield strength is selected. For example, it is preferable to use an ultra-super duralumin (A7075P) or 6Al-4V titanium alloy, and it is even more desirable to use a 6Al-6V-2Sn titanium alloy or an 11.5Al-1Mo-6Zr-4.5Sn titanium alloy.

In general, for a circular wheel in which the ratio of the inner radius to the outer radius is large (ratio>0.6), the rotational stress generated in the circumferential direction is much higher than the rotational stress generated in the radial direction. The rotary mass circular wheel of the integrated FESS of the present disclosure or in related art falls under the category.

Also in the second embodiment, since the CFRP rotary mass circular wheels 9A and 9B having the same specifications as those of the first embodiment are adopted, the requirements of the first step of the design process described above are satisfied, and the maximum wheel mass energy density D_{fw} (relative value) that is an order of magnitude higher than that of a high-strength metal mass circular wheel (SNCM439 and the like) can be obtained.

Further, since as in the first embodiment, the second embodiment also has a configuration in which the AFPM type M/G unit 3 including the rotor units 25A and 25B formed by the Halbach arrangement magnet array is adopted, and the rotor units 25A and are integrated with the flywheel hub 22A and 22B, the steel can be wiped out (removed or changed to a lightweight material) from the bulk components in related art.

As a result, in the second embodiment of the present disclosure, the large reduction of Mₒₜₕ is remarkably progressed, and the requirements of the second step of the design process described above are satisfied, so that not only the system size is miniaturized but also the improvement of the total maximum system mass energy density D_{sys} (corresponding to weight reduction) can also be achieved.

[Third Embodiment] The third embodiment relates to a configuration of the FESS of the present disclosure suitable for being equipped on a moving vehicle (an automobile, an aircraft, and the like).

When an external force (gravity, mechanical force, and the like) that changes the angle of the rotation shaft acts on a rotating object that rotates at high speed, such as a flywheel, a force is generated in the direction perpendicular to the external force (gyro effect). When the force is generated in the FESS on the moving vehicle, there arises a problem that traveling becomes unstable when the moving object changes direction in the up-down-left-right direction. The third embodiment of the present disclosure can solve the problem.

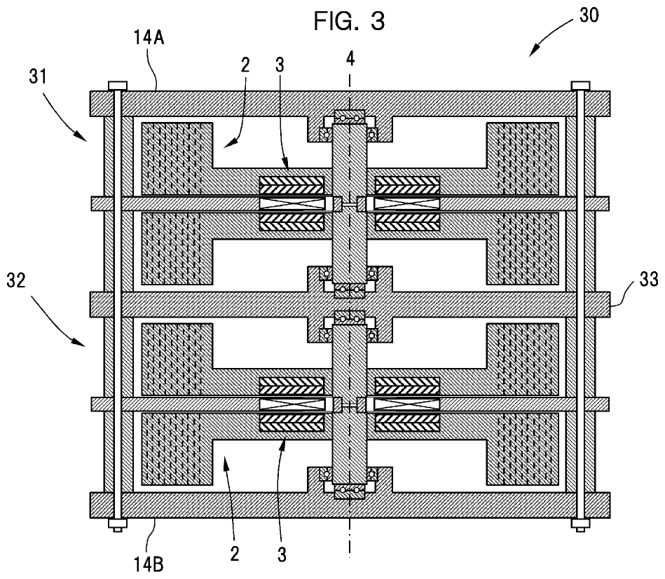

FIG. 3 is a cross-sectional view when a FESS 30 according to the third embodiment is cut along the rotation central axis 4 (Z-axis). The FESS 30 has a composite structure in which two flywheel energy storage units (a first flywheel energy storage unit 31 and a second flywheel energy storage unit 32) having the same configuration are vertically stacked such that the rotation central axes 4 coincide with each other.

Although the first flywheel power energy unit 31 and the second flywheel energy storage unit 32 are provided with one each, it may be acceptable when the same number is provided. The first flywheel energy storage unit 31 and the second flywheel energy storage unit 32 are driven to always rotate in opposite directions at an identical speed.

Both of the first energy storage unit 31 and second energy storage unit 32 correspond to the FESS in the first embodiment. Hereinafter, the same reference numerals and the description thereof will be omitted for the same components as those of the first embodiment.

A reference numeral 33 is a central support plate. As illustrated in FIG. 3, the disk-shaped central support plate 33 also serves as the lower support plate 14B of the first flywheel energy storage unit 31 and the upper support plate 14A of the second flywheel energy storage unit 32. Therefore, the lower bearing unit 15B of the first flywheel energy storage unit 31 is provided on the central upper surface, and the lower bearing unit of the second flywheel power storage unit 32 is provided on the central lower surface.

The material of the central support plate 33 is the same as that of the upper support plate 14A and the lower support plate 14B. A light metal having a high yield strength is selected. For example, it is preferable to use an ultra-super duralumin (A7075P) or 6Al-4V titanium alloy, and it is even more desirable to use a 6Al-6V-2Sn titanium alloy or an 11.5Al-1Mo-6Zr-4.5Sn titanium alloy.

In the FESS 30 according to the third embodiment, as described above, since a configuration is provided in which the flywheel energy storage units 31 and 32 having the same configuration at an identical speed and in the opposite rotation directions are stacked, although a moving object travels (or navigates) in which the angle of the rotary shaft of the flywheel energy storage device 30 is changed, the gyro effect force generated in the first flywheel energy storage unit 31 is offset by that in the second flywheel energy storage unit 32 and becomes substantially zero.

Accordingly, although the moving vehicle equipped with the flywheel energy storage device 30 can change the traveling direction (up, down, left, or right), stable traveling (or navigation) can be realized, which is a new effect.

Since the FESS 30 according to the third embodiment has a configuration in which the FESS according to the first embodiment or the second embodiment are stacked, a very high system mass energy density D_{sys} equivalent to the first embodiment or the second embodiment can be achieved.

[Fourth Embodiment] In general, a flywheel power storage device is required to be provided with a bidirectional inverter to drive the M/G (power supply and power reception). Strictly speaking, since the inverter is also a part of the components of the FESS, it is desirable that the inverter unit is also integrated with the flywheel unit and the M/G unit to reduce the size of the FESS including the inverter.

A FESS 40 of the fourth embodiment is made for the purpose of responding to the request.

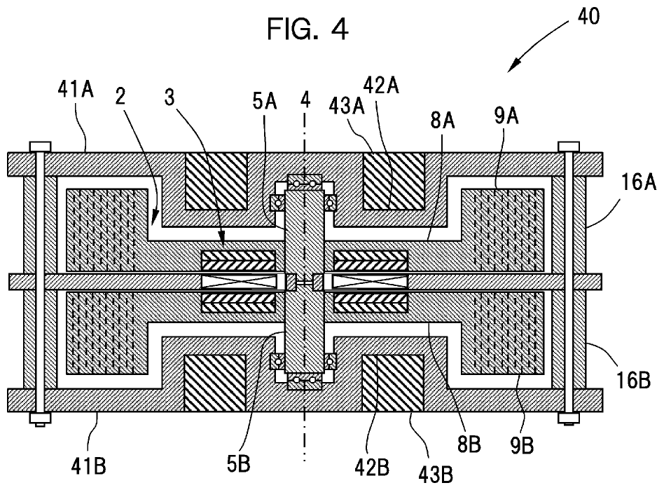

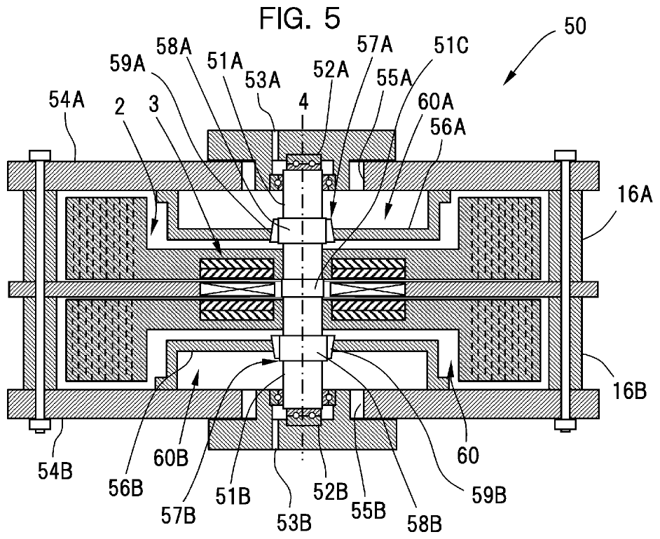

FIG. 4 is a cross-sectional view when the FESS 40 according to the fourth embodiment is cut along the rotation central axis 4 (Z-axis). The same components as those of the first embodiment are designated by the same reference numerals and the description thereof will be omitted.

Reference numerals 41A and 41B are an upper support plate and a lower support plate of the FESS 40. Similar to the support plates 14A and 14B of the first embodiment, connection is made in the upper bearing unit and the lower bearing unit at the central portion, but it is different from the first embodiment in that annular recesses 42A and 42B protruding toward the upper and lower flywheel hubs 8A and 8B between the rotary shafts 5A and 5B and the rotary mass circular wheels 9A and 9B are provided. The annular recesses 42A and 42B are formed corresponding to the annular space formed between the rotary shafts 5A and 5B and the rotary mass circular wheels 9A and 9B.

Bidirectional inverter units 43A and 43B that drive the M/G unit 3 are housed in the annular recesses 42A and 42B of the upper and lower support plates. Further, for example, when the bidirectional inverter unit 43B is completely housed in the one annular recess 42B, it is not necessary to provide the other annular recess 42A, and in that case, the upper support plate may be the upper support plate 14 of the first embodiment as it is.

As illustrated in FIG. 4, the FESS 40 according to the fourth embodiment is configured such that the free space created by the integration of the flywheel unit 2 and the M/G unit 3 of the first embodiment is partitioned by the support plates 41A and 41B, and the bidirectional inverter units 43A and 43B are accommodated in the recesses 42A and 42B, so that a high degree of integration in which the flywheel unit 2, the M/G unit 3, and the bidirectional inverter units 43A and 43B are integrated can be realized.

Furthermore, since a partition is provided between the flywheel unit 2 that rotates at high speed and the M/G unit 3, the bidirectional inverter units 43A and 43B, which are power electronics circuits, can operate stably without being affected thermo-mechanically from the flywheel unit 2 and the M/G unit 3.

[Fifth Embodiment] When the flywheel unit of the FESS is rotated at high speed, windage loss occurs between the flywheel surface and the atmosphere, so that the rotation speed decreases, and the stored energy density decreases. In order to prevent the above, it is conceivable to install a vacuum pumping device externally and exhaust the inside of the housing (in FIG. 1, the space surrounded by the upper support plate 14A, the lower support plate 14B, the upper support defense wall 16A, and the lower support defense wall 16B). In such a FESS since the vacuum pumping device is added as a part of the system, the system size increases by the amount of the vacuum device, and the degree of integration (the degree of miniaturization) of the system deteriorates.

A FESS 50 according to the fifth embodiment is made to solve such an additional problem, and a vacuum pumping device (for example, a spiral groove molecular pump) in related art is incorporated by using the rotary shaft and an internal empty space of the FESS 1 and 20 according to the first embodiment or the second embodiment.

FIG. 5 is a cross-sectional view when the FESS 50 according to the fifth embodiment is cut along the rotation central axis 4 (Z-axis). The same components as those in the first embodiment are designated by the same reference numerals, and the description thereof will be omitted.

Reference numerals 51A and 51B are an upper rotary shaft and a lower rotary shaft of the flywheel power storage device 50, and a reference numeral 51C is a coupling shaft. The upper rotary shaft 51A is supported by a detachable upper bearing unit 52A, and the lower rotary shaft 51B is supported by a detachable lower bearing unit 52B. The upper bearing unit 52A and the lower bearing unit 52B are provided with ventilation holes 53A and 53B.

The detachable upper and lower bearing units 52A and 52B are fitted into and connected to circular opening units 55A and 55B disposed in the upper support plate 54A and the lower support plate 54B, respectively.

A detachable upper bulkhead 56A that separates an upper space between an upper flywheel hubs (8A) space into a flywheel space 60 and an upper bearing side space 60A is attached to the upper support plate 54A. The upper bulkhead 56A has a opening portion in the center through which the upper rotary shaft 51A passes. Similarly, a detachable lower bulkhead 56B that separates a lower space between a lower flywheel hub (8B) space into the flywheel space 60 and a lower bearing side space 60B is attached to the lower support plate 54B.

A reference numeral 57A is an upper spiral groove molecular pump disposed in the upper space as a vacuum pumping device, and includes a spiral groove tapering 58A and a reverse tapered outer sheath ring 59A. The spiral groove tapering 58A is fitted to a predetermined position of the upper rotary shaft 51A.

On the other hand, the reverse tapered outer sheath ring 59A may be fitted into the central opening portion of the upper bulkhead 56A, or the side surface of the central opening portion of the upper bulkhead 56A may be directly machined to form a reverse tapered outer sheath. FIG. 5 is an example in which the reverse tapered outer sheath ring 59A is directly formed on the side surface of the central opening portion.

A reference numeral 57B is a lower spiral groove molecular pump, a reference numeral 58B is a lower spiral groove tapering, and a reference numeral 59B is a lower reverse tapered outer sheath ring.

When the FESS 50 operates and the flywheel unit 2 and the rotary shafts 51A and 51B start to rotate, the spiral groove molecular pumps 57A and 58B are activated, the air in the flywheel space 60 is evacuated toward the bearing side spaces 60A and 60B, and after a short time, the flywheel space becomes vacuum while the bearing side space still remains atmospheric pressure (external pressure). Since the flywheel space is maintained in a vacuum, windage loss generated on the flywheel surface can be eliminated.

In the fifth embodiment, since the empty space of the FESS 50 is utilized and the external vacuum pumping device is housed in the empty space, the volume of the vacuum pumping device can be reduced. As a result, the degree of integration is further increased, and dramatic miniaturization becomes possible.

[Sixth Embodiment] In the fourth embodiment, the FESS 40 is illustrated in which the bidirectional inverter units 43A and 43B are housed in the empty space of the FESS 1 of the first embodiment. On the other hand, in a fifth embodiment, the FESS 50 is illustrated in which the spiral groove molecular pumps 57A and 58B, which are vacuum pumping devices, are provided inside to draw a vacuum inside the housing of the FESS 1 of the first embodiment vacuum.

In a sixth embodiment described below, both the bidirectional inverter unit and the vacuum pumping device are housed in an empty space of the FESS 1 of the first embodiment to increase the degree of integration (miniaturization).

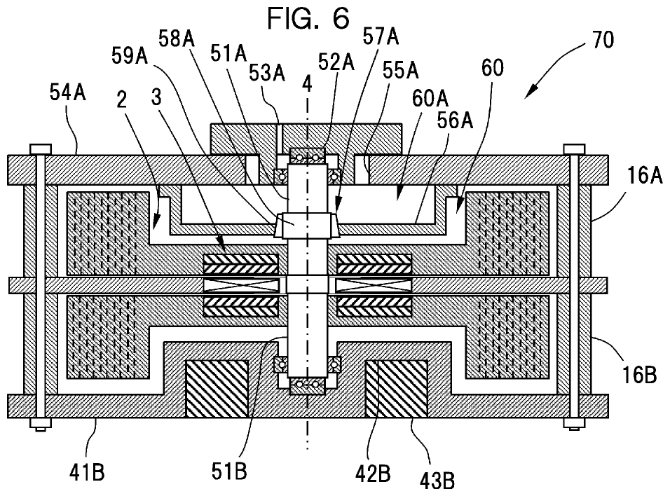

FIG. 6 is a cross-sectional view when a FESS 70 according to the sixth embodiment is cut along the rotation central axis 4 (Z-axis 4). The same components as those of the first, fourth, and fifth embodiments are designated by the same reference numerals, and the description thereof will be omitted.

In the FESS 70, the configuration above the central rotation plane 6 is the same as that of the upper half portion of the FESS 50 according to the fifth embodiment, and the configuration below the central rotation plane 6 is the same as that of the lower half portion of the FESS 40 of the fourth embodiment.

The spiral groove molecular pump 57A is incorporated in an upper portion, and the bidirectional inverter unit 43B is incorporated in a lower portion.

When the M/G unit 3 and the rotary shafts 51A and 51B start to rotate by the power supply of the bidirectional inverter unit 43B, the spiral groove molecular pump 57A is activated, the air in the flywheel space 60 is evacuated toward the bearing side space 60A, and after a short time, the flywheel space 60 becomes vacuum while the bearing side space 60A still remains atmospheric pressure (external pressure). Since the flywheel space 60 is maintained in a vacuum, windage loss generated on the surface of the flywheel can be eliminated.

In the sixth embodiment, since the spiral groove molecular pump 57A and the bidirectional inverter unit 43B are housed in the empty space of the FESS 1 of the first embodiment, it is possible to reduce the volume of the external vacuum exhaust device and the external bidirectional inverter at the same time. As a result, a higher degree of integration (miniaturization) can be obtained as compared with each of the first to fifth embodiments.

[Seventh Embodiment] With reference to FIG. 5 illustrating the fifth embodiment including the spiral groove molecular pumps 57A and 57B, a free space is recognized between the bearing units 52A and 52B and the bulkheads 56A and 56B. In the seventh embodiment, the degree of integration (miniaturization) is further increased by utilizing the space.

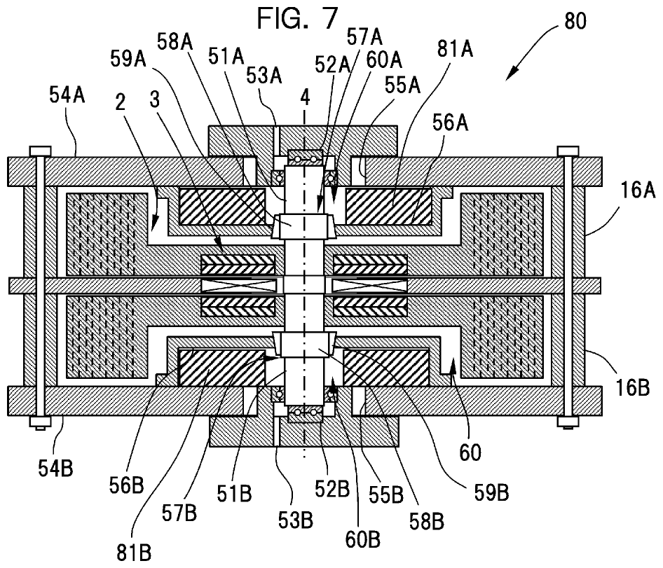

FIG. 7 is a cross-sectional view when a FESS 80 according to the seventh embodiment is cut along the rotation central axis 4 (Z-axis) 4. The same components as those of the first, fourth, and fifth embodiments are designated by the same reference numerals, and the description thereof will be omitted.

A reference numeral 81A is an upper bidirectional inverter unit disposed in the annular upper bearing side space 60A. The upper bidirectional inverter unit 81A is connected to the upper bulkhead 56A or the upper support plate 54A. Similarly, a reference numeral 81B is a lower bidirectional inverter unit disposed in the annular lower bearing side space 60B. The lower bidirectional inverter unit 81B is connected to the lower bulkhead 56B or the lower support plate 54B.

When the M/G unit 3 and the rotary shafts 51A, 51B, and 51C start to rotate by the power supply from the bidirectional inverter units 81A and 81B, the spiral groove molecular pumps 57A and 57B are activated, the air in the flywheel space 60 is evacuated toward the bearing side spaces 60A and 60B, and after a short time, the flywheel space 60 becomes vacuum while the bearing side spaces 60A and 60B still remain atmospheric pressure (external pressure). Since the flywheel space 60 is maintained in a vacuum, the present embodiment can eliminate windage loss generated on the surface of the flywheel unit 2 without an external vacuum pumping device.

In the seventh embodiment, since the spiral groove molecular pumps 57A and 57B, which are vacuum pumping devices, and the bidirectional inverter units 81A and 81B are housed in an empty space of the flywheel power storage device 1 of the first embodiment, it is possible to reduce the volume of the external vacuum pumping device and the external bidirectional inverter at the same time. As a result, a higher degree of integration (miniaturization) can be obtained as compared with each of the first to fifth embodiments.

### DESCRIPTION OF REFERENCE NUMERALS

1, 10, 20, 30, 40, 50, 70, 80 . . . flywheel energy storage system (FESS)
2 . . . flywheel unit
3 . . . an electrical motor/generator unit (M/G unit)
5B, 51A, 51B . . . rotary shaft (support shaft)
8A, 8B, 22A, 22B . . . flywheel hub
9A, 9B . . . rotary mass circular wheel
10, 24 . . . stator unit
11i . . . the coreless induction coil
12A, 12B . . . rotor unit
13Ai, 13Bi . . . permanent magnet array
21A, 21B . . . stationary shaft (support shaft)
31 . . . first flywheel energy storage unit (first energy storage unit)
32 . . . second flywheel energy storage unit (second energy storage unit)
43A, 43B . . . bidirectional inverter unit
57A, 57B . . . spiral groove molecular pump (vacuum pumping device)

1. A flywheel energy storage system comprising:
an electrical motor/generator unit configured to mutually convert electrical energy and rotational motion energy; and
a flywheel unit configured to store energy as rotational motion, wherein
the flywheel unit includes a support shaft of which a central axis coincides with a rotation axis of the flywheel unit, a pair of flywheel hubs coaxially supported by the support shafts, and a pair of rotary mass circular wheels provided on an outer periphery of each of the flywheel hubs,
the electrical motor/generator unit includes a stator unit formed by a coreless induction coil provided between the pair of flywheel hubs, and a rotor unit that faces the coreless induction coil of the stator unit and is formed by a yokeless annular permanent magnet Halbach array held by each of the flywheel hubs, and
a housing that supports the support shaft to accommodate both the electrical motor/generator unit and the flywheel unit.

2. The flywheel energy storage system according to claim 1, wherein
one or more, or all of the flywheel hub, the support shaft, and the housing are made of a light metal or a carbon fiber reinforced plastic.

3. The flywheel energy storage system according to claim 1, wherein
an annular space is formed between the rotary mass circular wheel and the support shaft of the flywheel unit, and
a bidirectional inverter unit configured to supply power to and receive power from the electrical motor/generator unit is accommodated in the annular space.

4. The flywheel energy storage system according to claim 1, wherein
a vacuum pumping device which is included inside the housing, the vacuum pumping device configured to evacuate air to produce a vacuum in at least a rotation area of the electrical motor/generator unit and the flywheel unit inside the housing.

5. The flywheel energy storage system according to claim 1, further comprising:
a second energy storage unit constituted by the electrical motor/generator unit and the flywheel unit; and
a second energy storage unit constituted by the electrical motor/generator unit and the flywheel unit that rotate in a reverse direction at an identical speed with respect to the first power storage unit, wherein
the first energy storage unit and the second energy storage unit are disposed with the same number on a same rotation axis.
